(19) United States
(12) Patent Application Publication
(10) Pub. No.: US 2005/0068312 A1
(43) Pub. Date: Mar. 31, 2005

(54) Method for programming a graphic control device with numeric and textual characters

(76) Inventor: Denny Jaeger, Oakland, CA (US)

Correspondence Address: Harris Zimmerman;Law Offices of Harris Zimmerman, Suite 710, 1330 Broadway, Oakland, CA, 94612-2506, US

(21) Appl. No.: 10/671,949

(22) Filed: Sep. 26, 2003

(51) Int. Cl. G09G 5/00; G09G 5/10; G06F 13/14; G09G 5/39

(52) U.S. Cl. 345/214; 345/690; 345/650; 345/661; 345/676; 345/660; 345/520; 345/531

(57) ABSTRACT

A method for programming graphic control devices, such as faders, allows a user to graphically associate numeric and/or textual characters with a graphic control device to program the device. As an example, the characters may be graphically associated with the graphic control device by dragging the characters to the device, drawing a graphic directional indicator (e.g., arrow), or grouping the characters and the device together. The numeric characters can be used to set the graphic control device to a setting that equals the numeric value represented by the numeric characters. In addition, the numeric characters can be used to define the range and the scaling resolution of the graphic control device. The textual characters can be used to assign or program the function of the graphic control device, such as volume control, as well as the label of the graphic control device.

### FIELD OF THE INVENTION

The invention relates generally to graphic control devices, and more particularly to a method for programming graphic control devices, such as faders.

### BACKGROUND OF THE INVENTION

Graphic control devices, such as faders, buttons and dials, used in various computer applications are usually programmed to perform predefined functions. As an example, an audio player application may include a volume control fader, a balance control fader, a base control fader and a treble control fader. The functions of these faders are programmed and usually cannot be changed by a user. Thus, a volume control fader usually cannot be changed to control, for example, the base. Similarly, the scaling resolutions of these faders are programmed and usually cannot be increased or decreased.

In some computer applications, the properties of graphic control devices may be modified by the user. However, the modification of these properties typically involves navigating through one or more menus to find the appropriate commands. For a novice user of these programs, finding these commands could be a challenging task. Furthermore, the location of these commands for modifying the graphic control devices usually varies from one application to the next. Thus, a user who is familiar with one application may have to become familiar with another application to modify the graphic control devices in that latter application.

In view of these disadvantages, what is needed is a method for programming graphic control devices in a straightforward manner without having to navigate through menus.

### SUMMARY OF THE INVENTION

A method for programming graphic control devices, such as faders, allows a user to graphically associate numeric and/or textual characters with a graphic control device to program the device. As an example, the characters may be graphically associated with the graphic control device by dragging the characters to the device, drawing a graphic directional indicator (e.g., arrow), or grouping the characters and the device together. The numeric characters can be used to set the graphic control device to a setting that equals the numeric value represented by the numeric characters. In addition, the numeric characters can be used to define the range and the scaling resolution of the graphic control device. The textual characters can be used to assign or program the function of the graphic control device, such as volume control, as well as the label of the graphic control device.

A method in accordance with an embodiment of the invention includes displaying a graphic control device that is controllable by a user to change a setting of the device, displaying characters in response to user input, graphically associating the characters with the graphic control device in response to user input, and programming a property of the graphic control device using the characters. The graphic association may be in response to a user dragging numeric and/or textual characters to intersect or be within a gap distance of a graphic control device, drawing an arrow from the characters to point to the device, or grouping the characters and the device together.

An embodiment of the invention includes a storage medium, readable by a computer, tangibly embodying a program of instructions executable by the computer to perform method steps for programming graphic control devices.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 illustrates the creation of a fader using hand drawn lines in accordance with an embodiment of the invention.

FIG. 2 illustrates the programming a fader by dragging textual characters in accordance with an embodiment of the invention.

FIG. 3 illustrates the programming a fader by dragging numeric characters in accordance with an embodiment of the invention.

FIG. 4 illustrates the programming a fader by dragging both numeric and textual characters in accordance with an embodiment of the invention.

FIG. 5 is a flowchart of a process for programming a graphic control device in accordance with an embodiment of the invention.

FIG. 6 is a diagram of a computer system in which the method for programming graphic control devices in accordance with an exemplary embodiment of the invention has been implemented.

FIG. 7 is a flow diagram of a method for programming a graphic control device in accordance with an embodiment of the invention.

FIG. 8 illustrates the drawing of a control arrow from numeric and textual characters and pointing the arrow to a fader to program the fader in accordance with another embodiment of the invention.

FIG. 9 illustrates the gluing of numeric and textual characters to a fader to program the fader in accordance with another embodiment of the invention.

### DETAILED DESCRIPTION

A method for programming graphic control devices in accordance with an embodiment of the invention allows a user to simply drag numeric and/or textual characters to a graphic control device to program that device. The numeric characters are used to set the graphic control device to a setting that equals the numeric value represented by the numeric characters. In addition, the numeric characters are also used to define the scaling resolution of the graphic control device. The textual characters are used to assign the function of the graphic control devices, such as volume control, as well as the label of the graphic control device. Thus, the method provides a simple straightforward manner with which to program graphic control devices.

The method is described herein with reference to faders. However, the method may be used to program any graphic control device that can be controlled by a user to change the setting of the device, such as dials, knobs, levers, switches, joysticks and buttons. In one embodiment, the method is embodied in a computer program running in a computer system. Thus, the method will sometimes be referred to herein as the computer program.

In accordance with the invention, a fader is first created (made to appear on the screen) in a computer operating environment in response to a user input. As an example, the computer operating environment may be a “Blackspace” environment. The word “Blackspace” is a trademark of the NBOR Corporation. Blackspace environment presents one universal drawing surface that is shared by all graphic objects within the environment. Blackspace environment is analogous to a giant drawing “canvas” on which all graphic objects generated in the environment exist and can be applied. Each of these graphic objects can have a user-created relationship to any or all the other objects. There are no barriers between any of the objects that are created for or exist on this canvas. However, the method is not limited to the Blackspace environment and can be used in any computer operating environment.

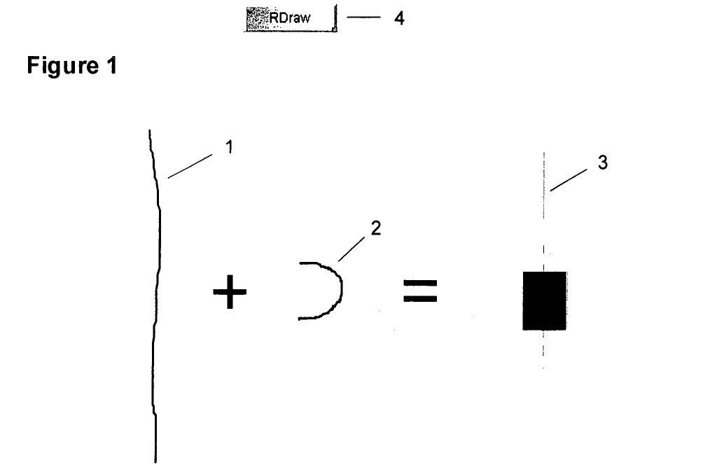

One way to create a fader is illustrated in FIG. 1. A user first turns on the drawing recognizing mode of the computer operating environment. The drawing recognizing mode is a state in which hand drawn objects, such as lines in a predefined arrangement, are recognized as predefined graphic objects. As an example, the drawing recognizing mode may be activated by turning on a recognize draw switch 4. The user then draws a vertical line 1 (or a horizontal line) followed by a C-shaped line 2 that intersects the first line. The C-shaped line 2 may be a reverse C-shaped line, as shown in FIG. 1, or even a circle. Once the lines 1 and 2 are drawn, these lines are recognized as a fader, and a graphic control device in the form of a fader 3 is displayed on the screen.

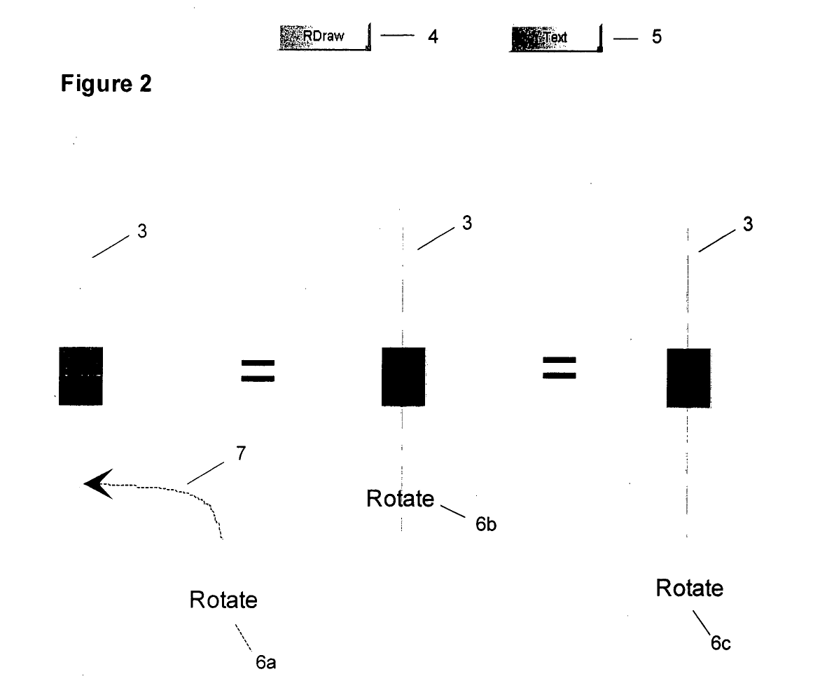

FIG. 2 illustrates the programming of the fader 3 with characters having only textual content to program the function of the fader. After the creation of the fader 3, the user activates the text mode, which is a state in which a user can type textual characters and/or numeric characters in the computer operating environment. As an example, the text mode may be activated by turning on a text mode switch 5. The user then types textual characters (a group of letters), e.g., “rotate” 6a, and drags the textual characters along a path 7 to intersect with any part of the fader 3, as illustrated by “rotate” 6b, or be within a default gap distance to the fader, and ensuring that the mouse button up-click occurs while the textual characters are within this distance to the fader. The gap distance defines a region about the fader 3 into which the characters can be dragged to program the fader. A suitable default for this gap distance is ½ inch. This default gap distance is a user-definable parameter, which can be selected, for example, in a menu.

The content of the textual characters is then analyzed in order to determine the function that the user desires to assign to the fader 3. Then the fader is programmed with this function, e.g., rotational control, which defines the behavior of the fader. As part of this process, the textual characters are snapped to a position adjacent to the fader 3, becoming the label for the fader, as illustrated by “rotate” 6c. The exact position of this label is not critical. As an example, the label may be positioned below the fader 3, as shown in FIG. 2, or be positioned above the fader.

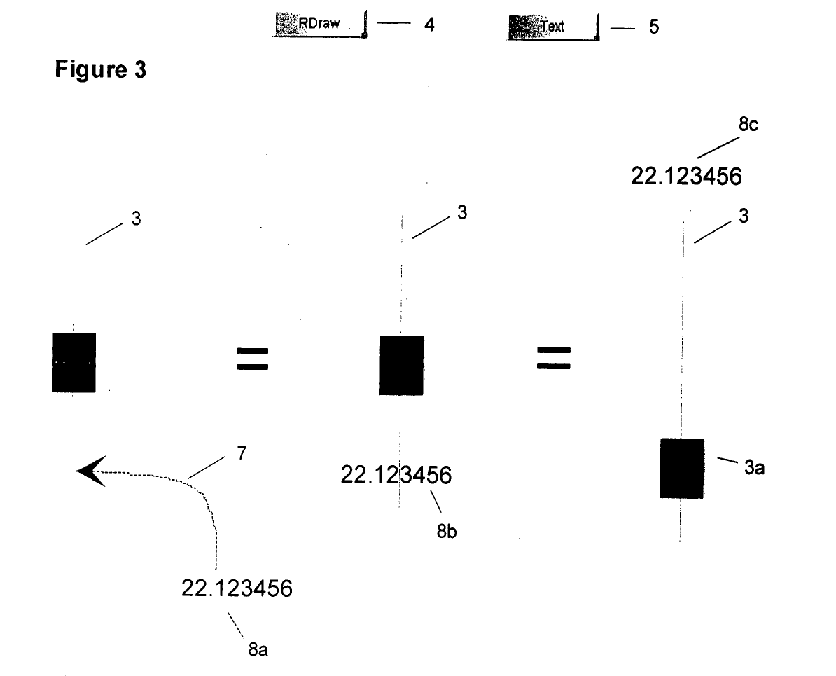

FIG. 3 illustrates the programming of the fader 3 with characters having only numeric content to program the numeric setting (value) and the scaling resolution of the fader. After the creation of the fader 3, the user activates the text mode. The user then types numeric characters (a number), e.g., “22.123456” 8a, and drags the numeric characters along a path 7 to intersect with any part of the fader 3, as illustrated by “22.123456” 8b, or be within a default gap distance to the fader, and ensuring that the mouse button up-click occurs while the numeric characters are within this distance to the fader. The numeric characters program the current setting of the fader to the value of the numeric characters. In addition, the numeric characters define the scaling resolution of the fader and the position of the fader's fader cap. In this example, the setting of the fader 3 will become “22.123456” and the fader cap 3a will be positioned relative to default minimum and maximum settings for the fader, e.g., “0” and “100”, respectively, that match the value of the dragged numeric characters. The default minimum and maximum settings define the range for the fader 3. These default minimum and maximum settings are user-definable parameters, which can be selected, for example, in a menu. Assuming a minimum setting of “0” and a default maximum setting of “100”, the fader cap will be positioned at approximately 22% of the maximum travel distance of the fader 3. In addition, the scaling resolution of the fader 3 will be changed from a default setting of, for example, whole integers to a resolution of six decimal points defined by the dragged numeric characters. As part of this process, the textual characters are snapped to a position adjacent to the fader 3, becoming the numeric value for the fader, as illustrated by “22.123456” 8c. The exact position of this value is not critical. As an example, the value may be positioned above the fader 3, as shown in FIG. 3, or be positioned below the fader.

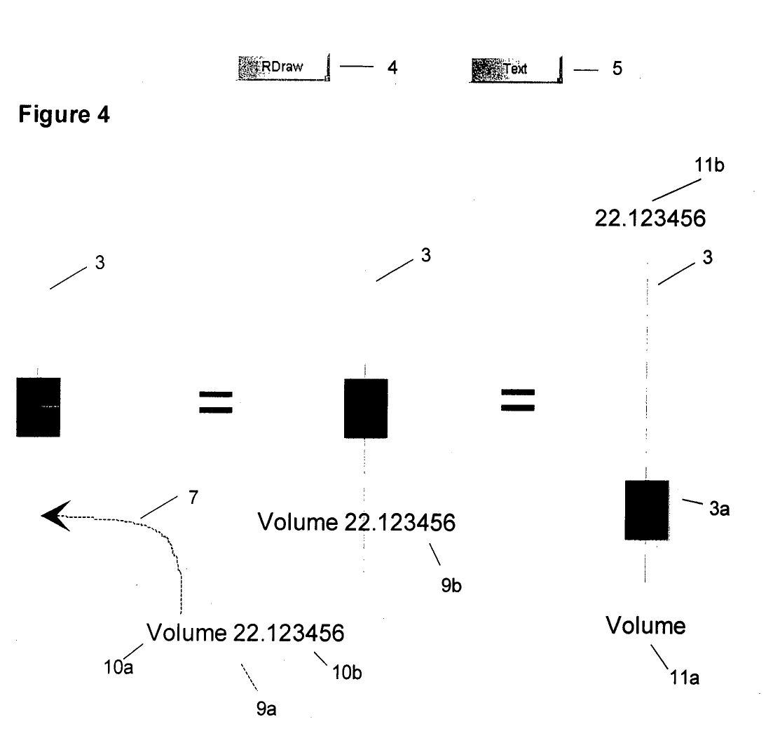

FIG. 4 illustrates the programming of the fader 3 with characters having both textual content and numeric content in accordance with an embodiment of the invention. After the creation of the fader 3, the user activates the text mode. The user then types characters, e.g., “volume 22.123456” 9a that contain both a textual portion “volume” 10a and a numeric portion “22.123456” 10b, and drags the characters along a path 7 to intersect with any part of the fader 3, as illustrated by “volume 22.123456” 8b, or be within a default gap distance to the fader, and ensuring that the mouse button up-click occurs while the numeric and textual characters are within this distance to the fader.

The textual portion 10a is used to program the function of the fader 3, as described above with reference to FIG. 2. The textual portion 10a is also used as the label for the fader 3. In this example, the function is volume control and “volume” is used as the label for the fader 3. The numeric portion 10b is used to program the current setting, the scaling resolution and the position of the fader cap 3a, as described above with reference to FIG. 3. As part of this process, the textual portion 10a and the numeric portion 10b of the dragged characters are separated and snapped to positions adjacent to the fader 3, as illustrated by “volume” 11a and “22.123456” 11c. The exact positions of the textual and numeric portions are not critical. As an example, the textual portion (the label) may be positioned below the fader 3 and the numeric portion may be positioned above the fader 3, as shown in FIG. 4, or vice versa.

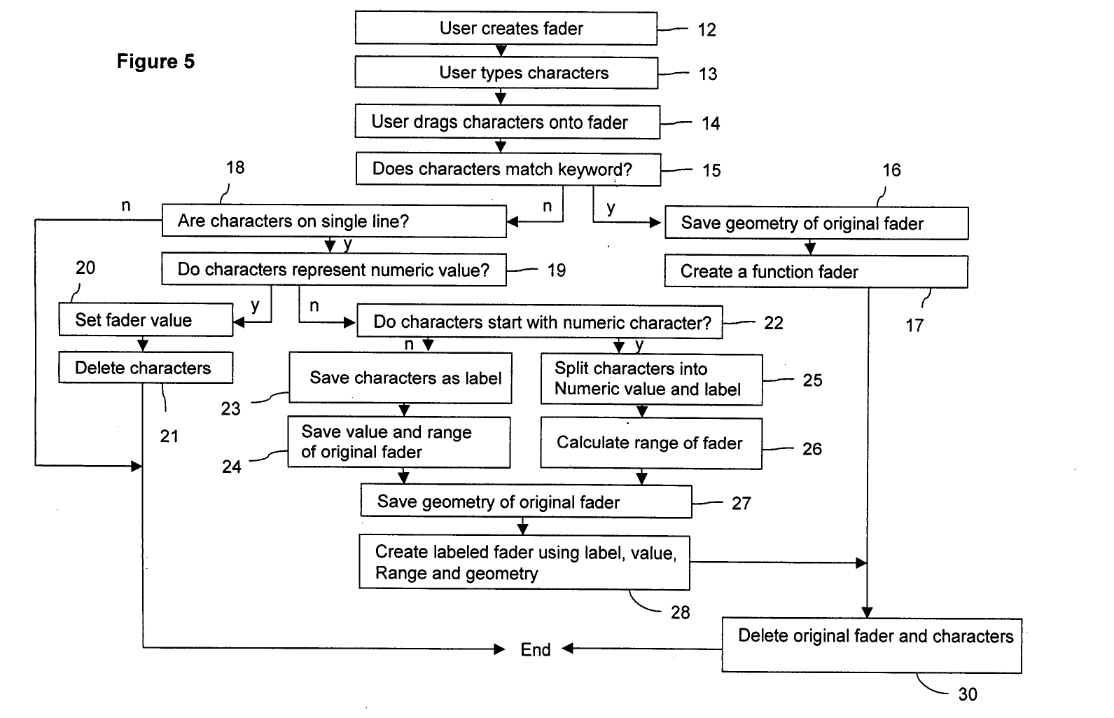

Turning now to FIG. 5, a flowchart of a process for programming a fader with characters is shown. This flowchart begins at step 12, where a user creates a fader, e.g., by drawing a horizontal or vertical line and a C-shaped line that intersects the first line. Next, at step 13, the user types characters that include textual and/or numeric characters. Next, at step 14, the user drags the characters to intersect or be within a defined gap distance to the fader.

Next, at step 15, a determination is made whether the characters match a keyword. The characters are compared to a list of known keywords. The characters are first passed though the equivalence system in order to determine if it is shorthand for a piece of text already specified by the user. The keywords identify known functions that faders can perform, such as volume control, brightness control, rotational control, etc. If the characters match a keyword, the geometry (position and size) of the original fader is saved, at step 16, and a fader is created to perform the specified function using this geometry, at step 17. The process then proceeds to step 30

If the characters do not match a keyword, another determination is made to determine whether the characters are on a single line, at step 18. If the characters are on multiple lines, then the assumption is that the user has accidentally placed the characters on top of the fader and this event is ignored. In this case, the process comes to an end. If the characters are on a single line, then another determination is made whether the characters represent a numeric value, at step 19. If the characters represent a numeric value, the fader is set to this value, at step 20. The characters are then deleted, at step 21, and the process comes to an end.

If the characters do not represent a numeric value, then a determination is made whether the characters start with a numeric character, at step 22. If no, the assumption is that all of the characters are intended to be a label for the fader. In which case, the characters are saved as a label, at step 23, and the value and range of the original fader are saved, at step 24. If the characters start with a numeric character, then the characters are split into a numeric value and a label, at step 25. That is, the characters are split into a numeric portion and a textual portion. The numeric portion may contain spaces, numbers 0-9 and a decimal point. Spaces are discarded. The numeric portion of the characters becomes the numeric value and the textual portion of the characters becomes the label. Next, at step 26, the range of the fader is calculated based on the numeric value and a scale factor. The scale factor may be set to a default of “10”. Alternatively, the user may have previously set the scale factor to another value by making a selection in a menu or its equivalent. The range of the fader is zero to the numeric value times the scale factor (the maximum value for the fader). The scale factor is different from a default fader range. The scale factor is a value by which the numeric value is multiplied by to define a new range for the fader.

Next, at step 27, the geometry of the original fader is saved. Next, at step 28, a labeled fader is created using the label, value, range and geometry, as previously determined. The original fader and the characters are then deleted, at step 30, and the process comes to an end.

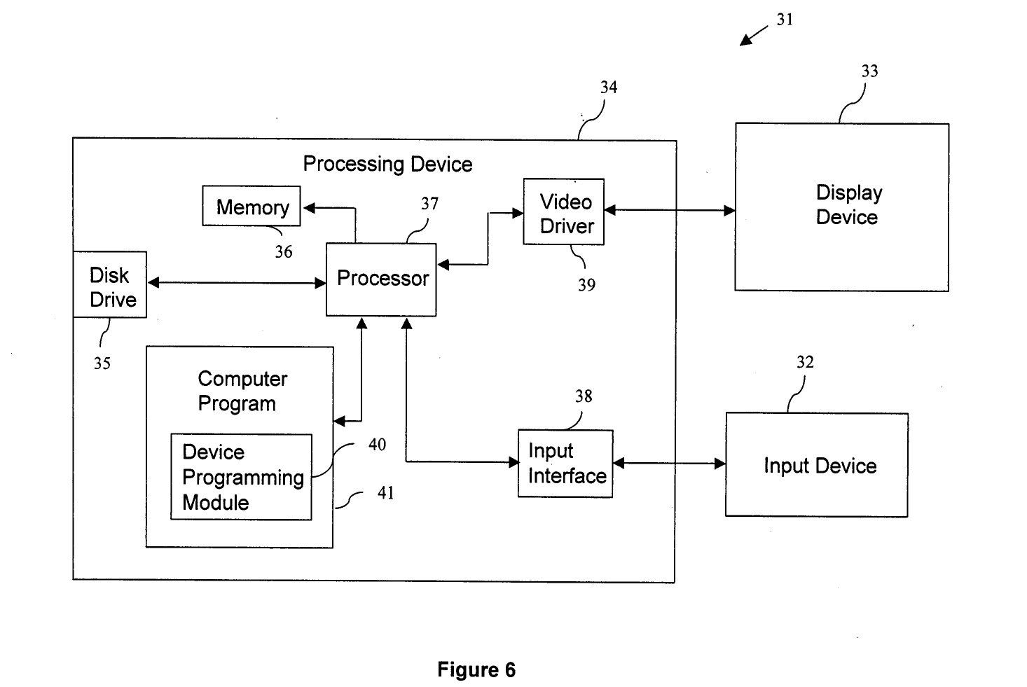

Turning now to FIG. 6, a computer system 31 in which the method for programming graphic control devices in accordance with an embodiment of the invention has been implemented is shown. The computer system 31 may be a personal computer, a personal digital assistant (PDA) or any computing system with a display device. In one embodiment, the method may be embodied in a computer readable storage medium, such as a CD, that includes instructions, which can be executed by the computer system 31, to implement the method in the system.

As illustrated in FIG. 6, the computer system 31 includes an input device 32, a display device 33 and a processing device 34. Although these devices are shown as separate devices, two or more of these devices may be integrated together. The input device 32 allows a user to input commands into the system 31 to, for example, enter numeric and/or textual characters that are to be used to program one or more faders. The input device 32 may include a computer keyboard and a mouse. However, the input device 32 may be any type of electronic input device, such as buttons, dials, levers and/or switches on the processing device 34. Alternative, the input device 32 may be part of the display device 33 as a touch-sensitive display that allows a user to input commands using a stylus. The display device 33 may be any type of a display device, such as those commonly found in personal computer systems, e.g., CRT monitors or LCD monitors.

The processing device 34 of the computer system 31 includes a disk drive 35, memory 36, a processor 37, an input interface 38, and a video driver 39. The processing device 34 further includes a device programming module 40, which performs various steps of the method. As shown in FIG. 6, the device programming module 40 may be implemented as part of a computer program 41, e.g., a Blackspace program that provides the Blackspace operating environment. In one embodiment, the device programming module 40 is implemented as software. However, the device programming module 40 may be implemented in any combination of hardware, firmware and/or software.

The disk drive 35, the memory 36, the processor 37, the input interface 38 and the video driver 39 are components that are commonly found in personal computers. The disk drive 35 provides a means to input data and to install programs into the system 31 from an external computer readable storage medium. As an example, the disk drive 35 may a CD drive to read data contained therein. The memory 36 is a storage medium to store various data utilized by the computer system 31. The memory 36 may be a hard disk drive, read-only memory (ROM) or other forms of memory. The processor 37 may be any type of digital signal processor that can run the computer program 41, including the device programming module 40. The input interface 38 provides an interface between the processing device 34 and the input device 32. The video driver 39 drives the display device 33. In order to simplify the figure, additional components that are commonly found in a processing device of a personal computer system are not shown or described.

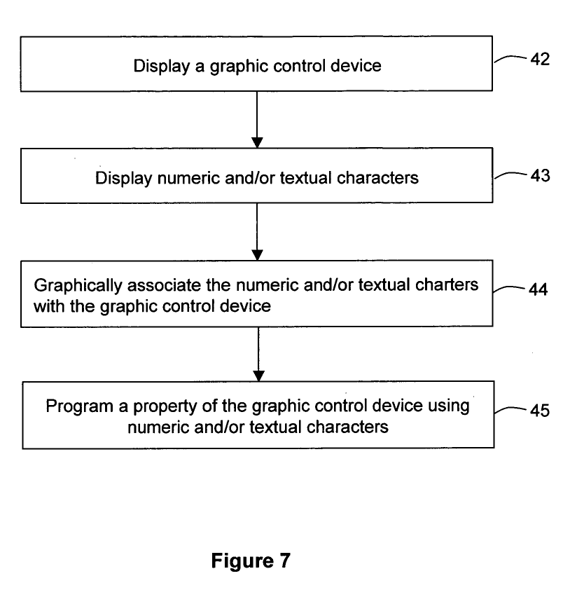

A method for programming graphic control devices, such as faders, in accordance with an embodiment of the invention is described with reference to a flow diagram of FIG. 7. At step 42, a graphic control device that is controllable by a user to change a setting of the device is displayed. Next, at step 43, numeric and/or textual characters are displayed. Next, at step 44, the numeric and/or textual characters are graphically associated with the graphic control device. The graphic association may involve moving the characters to intersect a region defined by the graphic control device. Alternatively, as described in more detail below, the graphic association may involve assigning a defined relationship between the graphic control device and the characters or grouping the device and characters together. Next, at step 45, a property of the graphic control device is programmed using the numeric and/or textual characters. The property of the graphic control device may include function, numerical setting (value), range, and scaling resolution.

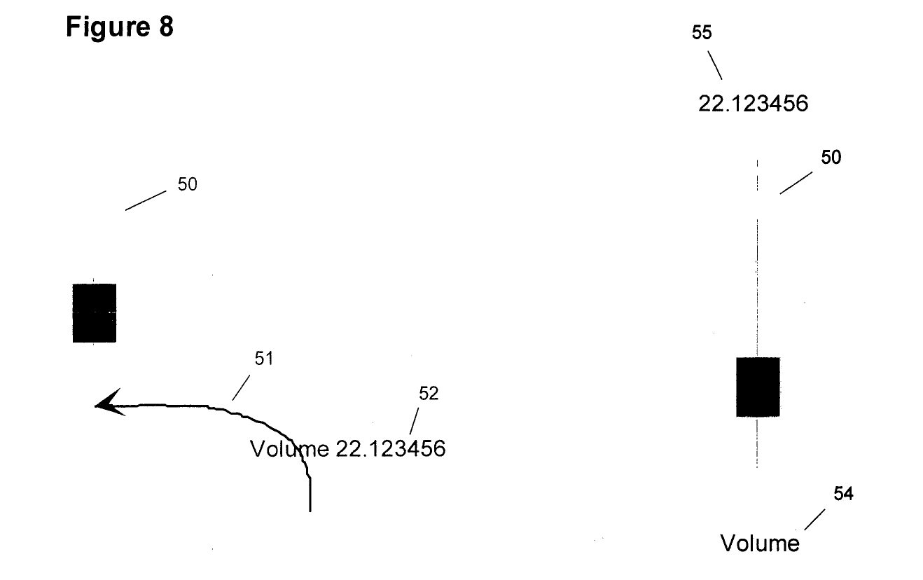

Referring now to FIG. 8, a method for programming graphic control devices in accordance with another embodiment of the invention is illustrated. In this embodiment, after numeric and/or textual characters 52 are entered, a control arrow 51 (or another type of graphic directional indicator) is drawn from the characters to a graphic control device, e.g., a fader 50, such that the arrow is pointing to the device, instead of dragging the characters to intersect or be within a default gap distance to the fader. When the arrow is recognized by the computer program, its arrowhead turns white (or its equivalent), which lets the user know that the context for the arrow is valid. In this case, the context is the drawing of a “control arrow” from numeric and/or textual characters and pointing the arrow to a control device. A control arrow is an arrow that has a “control arrow logic” assigned to it. This logic can be represented as a sentence which reads: “The item(s) that the arrow is drawn from will control the item(s) that the arrow is pointing to.” For more information pertaining to arrows and arrow logics, see pending U.S. patent application Ser. No. 09/880,397, entitled “Arrow Logic System for Creating and Operating Control Systems”, filed on Jun. 12, 2001, which is incorporated herein by reference.

When the white arrowhead is touched, the arrow logic for the arrow 51 is activated. Thus, an arrow logic relationship is assigned between the fader 50 and the characters 52. As a result, since the characters 52 include both a textual portion 54 and a numeric portion 55, the textual portion “volume” and the numeric portion “22.123456” snap to positions above and below the fader 50. These positions are arbitrary and are user-definable, e.g., in a menu. The numeric portion 55 programs the numeric setting of the fader 50, the resolution of the fader and the position of its fader cap. The textual portion 54 programs the function of the fader 50 and is used as the label for the fader. Similar to the first method, the fader 50 may be programmed using only numeric or textual characters.

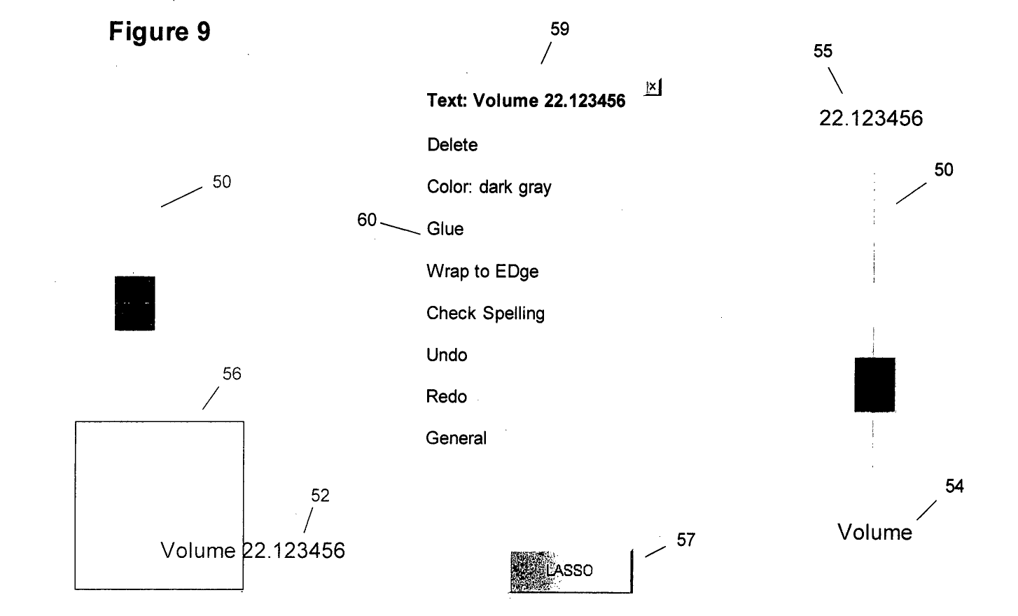

Referring now to FIG. 9, a method for programming graphic control devices in accordance with another embodiment of the invention is illustrated. In this embodiment, a control device, e.g., a fader 50, and numeric and/or textual characters 52 are grouped or glued together for the purpose of programming that control device. As an example, a lasso can be used to select the fader 50 and the characters 52 to group them together. In order to use a lasso, a Lasso switch 57 is turned on to activate the lasso tool. A lasso 56 is then drawn such that it intersects the fader 50 and the characters 52. Then the characters 52 are right-clicked on (or its equivalent) to make the Info Canvas object 59 for these characters visible onscreen. The term “Info Canvas” is a trademark of NBOR Corporation. The Info Canvas object 59 associated with the characters 52 provides entries, for example, to change the properties of the characters. Thus, the Info Canvas object 59 serves as a menu for the characters 52. For more information about Info Canvas objects, see simultaneously filed U.S. patent application Ser. No. ______, entitled “Intuitive Graphic User Interface with Universal Tools”, which is incorporated herein by reference.

Then in this Info Canvas object 59, the entry “Glue” 60 is turned on. Since the characters 52 include both a textual portion 54 and a numeric portion 55, the activation of the entry “Glue” 60 causes the characters to be split. The numeric portion 55 of these characters 52 appears above the fader 50 and the text portion 54 appears below the fader. Again, these positions are arbitrary and are user-definable, e.g., in a menu. The numeric portion 55 programs the numeric setting of the fader 50, the resolution of the fader and the position of its fader cap. The textual portion 54 programs the function of the fader 50 and is used as the label for the fader. Similar to the previously described methods, the fader 50 may be programmed using only numeric or textual characters.

Although specific embodiments of the invention have been described and illustrated, the invention is not to be limited to the specific forms or arrangements of parts so described and illustrated. The scope of the invention is to be defined by the claims appended hereto and their equivalents.

1. A method for programming a graphic control device, said method comprising:
displaying said graphic control device that is controllable by a user to change a setting of said graphic control device;
displaying characters in response to user input;
moving said characters to intersect a region defined by said graphic control device; and
programming a property of said graphic control device using said characters.

2. The method of claim 1 wherein said characters includes textual characters, and wherein said programming includes programming a function of said graphic control device, said function being associated with said textual characters.

3. The method of claim 2 further comprising labeling said graphic control device with said textual characters.

4. The method of claim 1 wherein said characters includes numeric characters, and wherein said programming of said property includes programming a numeric setting of said graphic control device, said numeric setting being defined by said numeric characters.

5. The method of claim 4 wherein said programming of said property includes programming a resolution of said graphic control device, said resolution being defined by said numeric characters.

6. The method of claim 4 wherein said programming of said property includes programming a range of said graphic control device, said range being at least partially defined by said numeric characters.

7. The method of claim 1 wherein said characters includes textual and numeric characters, and wherein said programming comprises:
programming a function of said graphic control device, said function being associated with said textual characters; and
programming a numeric setting of said graphic control device, said numeric setting being defined by said numeric characters.

8. The method of claim 7 wherein said programming of said property includes programming a resolution of said graphic control device, said resolution being defined by said numeric characters.

9. The method of claim 7 wherein said programming of said property includes programming a range of said graphic control device, said range being at least partially defined by said numeric characters.

10. The method of claim 1 wherein said displaying of said graphic control device includes recognizing a hand drawn object as said graphic control device.

11. A storage medium readable by a computer, tangibly embodying a program of instructions executable by said computer to perform method steps for programming a graphic control device, said method steps comprising:
displaying said graphic control device that is controllable by a user to change a setting of said graphic control device;
displaying characters in response to user input;
moving said characters to intersect a region defined by said graphic control device; and
programming a property of said graphic control device using said characters.

12. The storage medium of claim 11 wherein said characters includes textual characters, and wherein said programming includes programming a function of said graphic control device, said function being associated with said textual characters.

13. The storage medium of claim 12 further comprising labeling said graphic control device with said textual characters.

14. The storage medium of claim 11 wherein said characters includes numeric characters, and wherein said programming of said property includes programming a numeric setting of said graphic control device, said numeric setting being defined by said numeric characters.

15. The storage medium of claim 14 wherein said programming of said property includes programming a resolution of said graphic control device, said resolution being defined by said numeric characters.

16. The storage medium of claim 11 wherein said programming of said property includes programming a range of said graphic control device, said range being at least partially defined by said numeric characters.

17. The storage medium of claim 11 wherein said characters includes textual and numeric characters, and wherein said programming comprises:
programming a function of said graphic control device, said function being associated with said textual characters; and
programming a numeric setting of said graphic control device, said numeric setting being defined by said numeric characters.

18. The storage medium of claim 17 wherein said programming of said property includes programming a resolution of said graphic control device, said resolution being defined by said numeric characters.

19. The storage medium of claim 17 wherein said programming of said property includes programming a range of said graphic control device, said range being at least partially defined by said numeric characters.

20. The storage medium of claim 11 wherein said displaying of said graphic control device includes recognizing a hand drawn object as said graphic control device.

21. A method for programming a graphic control device, said method comprising:
displaying said graphic control device that is controllable by a user to change a setting of said graphic control device;
displaying characters in response to user input;
graphically associating said characters to said graphic control device in response to user input; and
programming a property of said graphic control device using said characters.

22. The method of claim 21 wherein said graphically associating includes assigning a relationship between said characters and said graphic control device in response a graphic directional indicator drawn from said characters to said graphic control device.

23. The method of claim 22 wherein said graphic directional indicator includes an arrow.

24. The method of claim 21 wherein said graphically associating includes grouping said characters and said graphic control device together in response said user input.
